(19) United States
(12) Patent Application Publication
(10) Pub. No.: US 2024/0315322 A1
(43) Pub. Date: Sep. 26, 2024

(54) CIGARETTE FILTER AND CIGARETTE COMPRISING SAME

(71) Applicant: KT&G CORPORATION, Daejeon (KR)

(72) Inventors: Ki Jin AHN, Daejeon (KR); Hyeon Tae KIM, Daejeon (KR); Sun Hwan JUNG, Daejeon (KR); Min Hee HWANG, Daejeon (KR)

(73) Assignee: KT&G CORPORATION, Daejeon (KR)

(21) Appl. No.: 18/577,819

(22) PCT Filed: Oct. 20, 2022
(86) PCT No.: PCT/KR2022/015986

§ 371 Date: Jan. 9, 2024

(30) Foreign Application Priority Data
Oct. 20, 2021 (KR) 10-2021-0140315

(51) Int. Cl. A24D 3/10; A24D 1/02

(52) U.S. Cl. CPC A24D 3/10; A24D 1/02

(57) ABSTRACT

The present invention relates to a cigarette filter and a method for manufacturing same, and can provide a paper cigarette filter using paper and a cigarette comprising same. A cigarette filter according to one embodiment of the present invention can impart a high degree of smoking satisfaction through high granule stability, and eliminate a burnt taste. Hereinafter, various embodiments related to a cigarette filter and a method for manufacturing same may be possible.

### TECHNICAL FIELD

The present disclosure relates to a cigarette filter and a cigarette including the same.

### BACKGROUND ART

Generally, in order to manufacture a cigarette, various types of leaf tobacco are mixed and processed to obtain desired aroma and taste. Then, the processed leaf tobacco is cut to produce cut tobacco leaves. The tobacco leaves may be wrapped by cigarette paper to produce a cigarette, and if necessary, a filter may be attached to the cigarette.

Filters used in cigarettes may be broadly divided into an acetate filter, a paper filter, and a charcoal filter. An acetate filter commonly produced includes cellulose acetate tow, and activated carbon and a plasticizer are added to the cigarette filter.

The above description has been possessed or acquired by the inventor(s) in the course of conceiving the present disclosure and is not necessarily an art publicly known before the present application is filed.

### DISCLOSURE OF THE INVENTION

### Technical Goals

To solve the above issues, the present disclosure provides a cigarette filter including paper.

According to an embodiment of the present disclosure, there is provided a cigarette filter containing a large amount of granules and a moisturizing agent as a cigarette filter including granules.

According to an embodiment of the present disclosure, there is provided a method of producing a cigarette filter including granules.

However, goals to be achieved are not limited to those described above, and other goals not mentioned above are clearly understood by one of ordinary skill in the art from the following description.

### Technical Solutions

A cigarette filter according to an example of the present disclosure may include a paper filter that is formed by rolling base paper, a moisturizing agent that is applied to at least a portion of a surface of the paper filter, granules that are bound to the moisturizing agent, and a filter wrapper that wraps the paper filter.

A cigarette according to an example of the present disclosure may include a cigarette column portion, a cigarette filter portion that is positioned at one side of the cigarette column portion and includes one or more cigarette filters, and a tip paper that wraps the cigarette filter portion and a portion of the cigarette column portion.

A method of manufacturing a cigarette filter according to an embodiment of the present disclosure may include generating crimped paper by crimping base paper, applying a moisturizing agent to the crimped paper through a plurality of nozzles, injecting granules onto the paper containing the moisturizing agent, and packaging the paper, on which the granules are seated, with a filter wrapper.

### Effects

The present disclosure may provide a cigarette filter including paper.

According to an embodiment of the present disclosure, it is possible to provide a cigarette filter containing a large amount of granules and a moisturizing agent as a cigarette filter including granules.

According to an embodiment of the present disclosure, it is possible to provide a method of manufacturing a cigarette filter including granules.

### BRIEF DESCRIPTION OF DRAWINGS

FIG. 1 is a perspective view showing a cigarette according to an embodiment of the present disclosure.

FIG. 2 is a cross-sectional view of a cigarette column portion according to an embodiment of the present disclosure.

FIG. 3 is a flowchart of a manufacturing process of a cigarette filter according to an embodiment of the present disclosure.

FIG. 4 is a schematic diagram of a manufacturing device for a cigarette filter according to an embodiment of the present disclosure.

FIG. 5 is a conceptual diagram of a method of applying a moisturizing agent in a moisturizing agent application device according to an embodiment of the present disclosure.

### BEST MODE FOR CARRYING OUT THE INVENTION

Hereinafter, example embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, the terms such as first, second, A, B, (a), (b) or the like may be used to describe components of the embodiments. Each of these terms is not used to define an essence, order or sequence of a corresponding component but used merely to distinguish the corresponding component from other component(s). It is to be understood that if a component is described as being “connected”, “coupled” or “joined” to another component, the former may be directly “connected”, “coupled”, and “joined” to the latter or “connected”, “coupled”, and “joined” to the latter via another component.

Components included in an embodiment and components having a common function will be described using the same names in other embodiments. Unless otherwise mentioned, the descriptions on the embodiments may be applicable to the following embodiments and thus, duplicated descriptions will be omitted for conciseness.

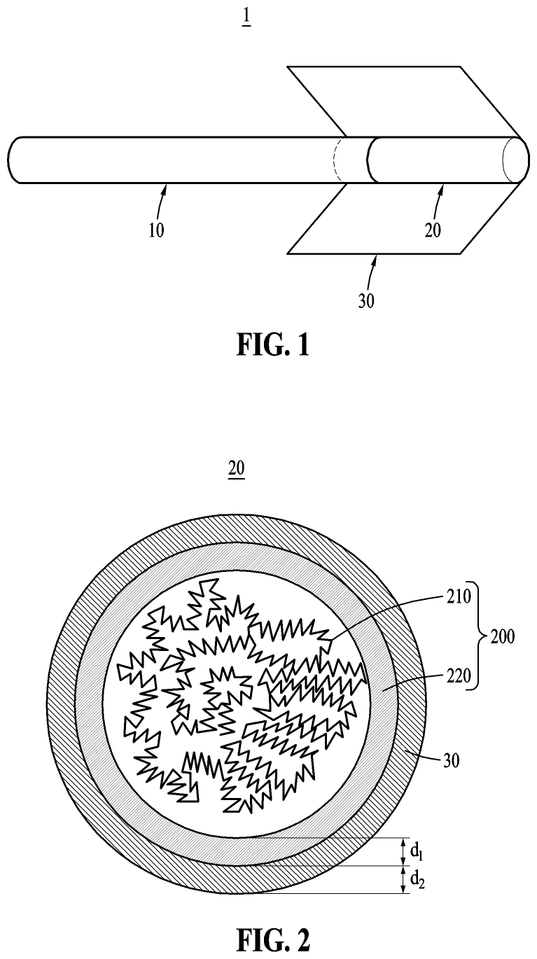

FIG. 1 is a perspective view showing a cigarette according to an embodiment of the present disclosure.

According to an embodiment, a cigarette 1 may include a cigarette column portion 10, a cigarette filter portion 20 positioned at one side of the cigarette column portion 10, and a tip paper 30 wrapping the cigarette filter portion 20 and a portion of the cigarette column portion 10.

According to an embodiment, the cigarette filter portion 20 may include one or more cigarette filters. According to an embodiment, the cigarette filter portion 20 may include a single cigarette filter, or may include two or more cigarette filters positioned continuously in a longitudinal direction of the cigarette 1.

According to an embodiment, mainstream smoke may be generated as the cigarette column portion 10 of the cigarette 1 is heated, and this may flow to the cigarette filter portion 20 from the cigarette column portion 10 in the longitudinal direction of the cigarette 1 to be inhaled by a user.

According to an embodiment, the “longitudinal direction” may refer to a longitudinal direction of the cigarette 1, the cigarette column portion 10, and/or the cigarette filter portion 20, and specifically, a direction parallel to a height of the cigarette 1, the cigarette column portion 10, and/or the cigarette filter portion 20 having a cylindrical shape. The meaning of the “longitudinal direction” may be used throughout this specification.

FIG. 2 is a cross-sectional view of a cigarette column portion according to an embodiment of the present disclosure.

According to an embodiment of the present invention, a cigarette filter portion 20 may include a cigarette filter 200, and a tip paper 30 wrapping the cigarette filter 200. According to an embodiment, the cigarette filter 200 may include a paper filter 210, and a filter wrapper 220 wrapping the paper filter 210. The paper filter 210 may be made of base paper crimped through a crimping process. The base paper may be crimped to generate crimped paper. In this case, the crimping process may be compressing and crumpling the base paper, or processing the base paper by passing it between two or more rollers.

According to an embodiment, the cigarette filter 200 may include a moisturizing agent applied to at least a portion of a surface of the paper filter 210. The moisturizing agent may be sprayed and applied to an entire portion or a portion of the surface of the paper filter 210. As the cigarette filter 200 includes the paper filter 210 containing the moisturizing agent, a desired level of suction resistance (pressure drop (PD)) may be achieved. The suction resistance may refer to resistance of air felt by a user when the user inhales air while holding a cigarette in the mouth. Since satisfaction of smoking felt by the user may vary depending on the suction resistance, it is necessary to achieve desired suction resistance.

According to an embodiment, the cigarette filter 200 may include granules, and the granules may be bound to the moisturizing agent. The moisturizing agent and the granules may be combined by injecting the granules to the paper filter 210 that contains the moisturizing agent by spraying the moisturizing agent to the entire portion or a portion of the surface of the paper filter 210. The moisturizing agent may function as a binder for combining the granules with paper and may prevent the granules from falling off the paper filter 210. In a case of granules injected to an area of the surface of the paper filter 210 where the moisturizing agent is not applied, the granules may fall off due to insufficient binding force with the paper filter 210.

According to an embodiment, a content of the granules may be 0.3% by mass to 5% by mass with respect to a total content of the cigarette filter portion 20.

According to an embodiment, the filter wrapper 220 may have a predetermined thickness d¹, and the tip paper 30 wrapping the cigarette filter 200 may have a predetermined thickness d₂.

According to an embodiment, the filter wrapper 220 may have a cylindrical shape to be wrapped around the paper filter 210. The thickness d₁ of the filter wrapper 220 may be about 5 micrometers (μm) to about 30 μm. According to an embodiment, as the filter wrapper 220 has the thickness d¹ within the range of numerical values described above, heat may be appropriately transferred to the entire portion of the cigarette filter 200, and the leakage of a liquid component (e.g., the moisturizing agent) in the cigarette filter 200 from the inside to the outside may be prevented or reduced. According to an embodiment, as the filter wrapper 220 has the thickness d¹ within the range of numerical values described above, a tensile strength of the filter wrapper 220 may be improved.

According to an embodiment, the filter wrapper 220 may include at least one of aluminum (Al), copper (Cu), zinc (Zn), gold (Au), or iron (Fe). According to an embodiment, the filter wrapper 220 may have a cylindrical shape formed of a thin metal film, and the filter wrapper 220 may have a cylindrical shape formed of, for example, an aluminum foil, copper foil, or silver foil. According to an embodiment, as the filter wrapper 220 is formed in a cylindrical shape formed of a thin metal film, heat may be appropriately transferred to the entire portion of the cigarette filter 200, and the leakage of a liquid component (e.g., the moisturizing agent) in the cigarette filter 200 from the inside to the outside may be prevented or reduced.

According to an embodiment, the thickness d₂ of the tip paper 30 may be about 5 μm to about 30 μm. According to an embodiment, the tip paper 30 may be wrapped around the cigarette filter portion 20 and a portion of the cigarette column portion 10, and the filter wrapper 220 of the cigarette filter 200 may be wrapped by the tip paper 30.

According to an embodiment, the tip paper 30 may include cellulose or dextrin. For example, the tip paper 30 may include cellulose.

According to an embodiment, a total thickness d₁+d₂ of the filter wrapper 220 and the tip paper 30 may be about 30 μm to 100 μm. According to an embodiment, as the total thickness of the filter wrapper 220 and the tip paper 30 is the thickness d₁+d₂ within the range of numerical values described above, the leakage of a liquid component (e.g., the moisturizing agent) in the cigarette filter 200 from the inside to the outside may be prevented or reduced.

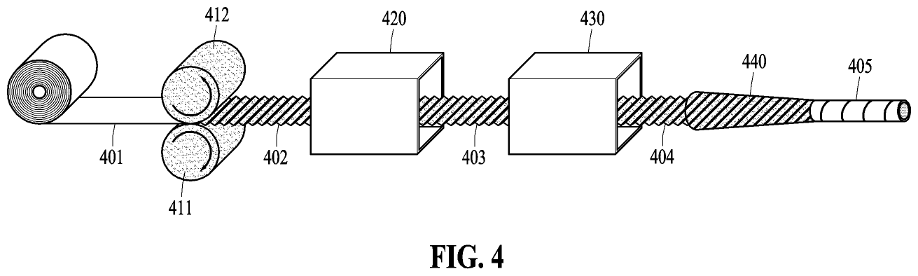

According to an embodiment, the base paper may be used to manufacture the paper filter 210 included in the cigarette filter 200. According to an embodiment, the performance (e.g., the suction resistance) of the cigarette filter 200 may be determined based on physical and chemical properties such as the type and surface characteristics (e.g., a porosity or moisture permeability) of base paper (base paper 401 of FIG. 4). According to an embodiment, the properties of the moisturizing agent applied to the surface of the base paper and adhesion thereof to the granules may be improved according to the type and the surface characteristics of the base paper.

According to an embodiment, the base paper may have a low porosity. According to an embodiment, if the base paper has a large number of pores, the moisturizing agent may be easily absorbed into the pores, making it difficult for the moisturizing agent to form on a surface of the base paper. According to an embodiment, the porosity of the base paper may be calculated by measuring Gurley porosity using TAPPI T460, and the porosity of the base paper may be 10 s/100cc³ or less. According to an embodiment, the porosity of the base paper may be 9 s/100cc³ or less, 8 s/100cc³ or less, 7 s/100cc³ or less, 6 s/100cc³ or less, 5 s/100cc³ or less, 4 s/100cc³ or less, 3 s/100cc³ or less, 2 s/100cc³ or less, or 1 s/100cc³ or less.

According to an embodiment, when the porosity of the base paper is 10 s/100cc³ or less, the moisturizing agent may be easily formed on the surface of the base paper, and the adhesion thereof with the injected granules may be improved. According to an embodiment, when the porosity of the base paper is 10 s/100cc³ or less, stability and dispersibility of the granules may be increased.

According to an embodiment, as a basis weight and thickness of the base paper are small, a width of the base paper of the paper filter 210 applied to the cigarette filter 200 may be increased, thereby improving adhesion to the granules injected and stability of the granules. According to an embodiment, the base paper may have a basis weight of 15 g/m² to 30 g/m². According to an embodiment, the basis weight of the base paper may be 15 g/m² or more, 16 g/m² or more, 17 g/m² or more, 18 g/m² or more, 19 g/m² or more, 20 g/m² or more, 21 g/m² or more, 22 g/m² or more, 23 g/m² or more, 24 g/m² or more, 25 g/m² or more, 26 g/m² or more, 27 g/m² or more, 28 g/m² or more, or 29 g/m² or more, 29 g/m² or less, 28 g/m² or less, 27 g/m² or less, 26 g/m² or less, 25 g/m² or less, 24 g/m² or less, 23 g/m² or less, 22 g/m² or less, 21 g/m² or less, 20 g/m² or less, 19 g/m² or less, 18 g/m² or less, 17 g/m² or less, or 16 g/m² or less, or may be included in a range between two values selected from the above values. According to an embodiment, the basis weight of the base paper may be desirably 16 g/m² to 26.5 g/m².

According to an embodiment, the base paper may have a width of 200 millimeters (mm) to 300 mm. According to an embodiment, the width of the base paper is a factor that determines the circumference of the paper filter 210 of the cigarette filter 200, and the paper filter 210 is a filter formed by crimping the base paper, and may be formed by rolling the base paper in a direction perpendicular to the longitudinal direction of the cigarette 1. According to an embodiment, the width of the base paper may determine the circumference of the cylindrical paper filter 210 included in the cigarette filter 200. According to an embodiment, the width of the base paper may be measured as a length in the direction perpendicular to the longitudinal direction of the cigarette 1 when the rolled paper filter 210 is unfolded to be flat.

According to an embodiment, the width of the base paper may be 200 mm or more, 210 mm or more, 220 mm or more, 230 mm or more, 240 mm or more, 250 mm or more, 260 mm or more, 270 mm or more, 280 mm or more, 290 mm or more, 290 mm or less, 280 mm or less, 270 mm or less, 260 mm or less, 250 mm or less, 240 mm or less, 230 mm or less, 220 mm or less, or 210 mm or less, or may be included in a range between two values selected from the above values.

According to an embodiment, if the width of the base paper is beyond the above numerical range, the circumference of the cylindrical paper filter 210 formed by rolling the base paper may be excessively small or large, and in a case of manufacturing the cylindrical paper filter 210 having the same circumference as the cigarette column portion 10, an internal space of the cigarette filter 200 may be extremely large or narrow, thereby degrading the ability to remove harmful components of the mainstream smoke and/or performance of passage of the mainstream smoke.

According to an embodiment, a product of the width and the basis weight of the base paper may be 5.2 g/m to 5.6 g/m. According to an embodiment, when the product of the width and the basis weight of the base paper is included in the above numerical range, a filter may be smoothly manufactured and the suction resistance (e.g., about 80 mmWG) may be easily achieved. In addition, according to an embodiment, when the product of the width and the basis weight of the base paper is included in the above numerical range, the granules injected to the paper filter 210 may be easily seated without falling, and uniformity of smoking taste felt by the user of the cigarette 1 may be improved.

According to an embodiment, the paper filter 210 has a cylindrical shape and may have the circumference of 20 mm to 25 mm. According to an embodiment, the paper filter 210 may be formed by rolling the base paper in a cylindrical shape. According to an example, the paper filter 210 may have a cylindrical shape having the circumference of desirably 20 mm to 24 mm, and more desirably 21 mm to 23 mm. According to an embodiment, the paper filter 210 may be formed by crimping the base paper and rolling the crimped paper, and may be manufactured by rolling the base paper to have a cylindrical shape when rolled. In this case, the circumference of the paper filter 210 may be the circumference of a bottom surface after being rolled in the cylindrical shape, and may be replaced with the circumference of the cigarette filter 200, since the thickness of the filter wrapper 220 is thinner than that of the paper filter.

According to an embodiment, the moisturizing agent may be applied to at least a portion of the surface of the paper filter 210 and thus may be positioned so that the moisturizing agent is formed on the surface of the paper filter 210. According to an embodiment, the moisturizing agent may include at least one of glycerin, guar gum, starch, methyl cellulose, ethylene vinyl acetate (EVA), gum arabic, or propylene glycol.

According to an embodiment, if an excessively large amount of moisturizing agent is applied to the surface of the paper filter 210, the stability of the granules may be reduced, and if an excessively small amount of moisturizing agent is applied to the surface of the paper filter 210, the granules may easily fall off. According to an embodiment, the amount of moisturizing agent applied to the surface of the paper filter 210 based on the longitudinal direction of the cigarette 1 and/or the paper filter 210 may be 0.5 mg/mm to 5 mg/mm. According to an embodiment, the amount of moisturizing agent applied to the surface of the paper filter 210 may be 4 mg/mm or less, 3 mg/mm or less, 2 mg/mm or less, or 1 mg/mm or less, desirably 0.5 mg/mm to 4 mg/mm, 0.5 mg/mm to 3 mg/mm, or 0.5 mg/mm to 2 mg/mm.

According to an embodiment, the cigarette filter 200 may include granules. According to an embodiment, the granules may be injected to and seated on the paper filter 210, and the moisturizing agent in this case may improve the binding force with the paper filter 210. According to an embodiment, the granules may have coating layers formed on surfaces thereof. According to an embodiment, the coating layers formed on the surfaces of the granules may prevent the granules from being broken or smashed. The granules may be broken by the moisturizing agent, broken by an external impact, or may be naturally broken or smashed over time. According to an embodiment, the coating layers formed on the surfaces of the granules may protect the granules from the external impact.

According to an embodiment, the coating layer may include at least one of microcrystalline cellulose, anhydrous lactose, Cellactose 80 (75% of microcrystalline cellulose and 25% of lactose which are co-processed), isomalt, dibasic dihydrate calcium phosphate, calcium carbonate, calcium lactate, dibasic anhydrous calcium phosphate, tribasic calcium phosphate, calcium silicate, calcium sulfate, carbomer, carboxymethyl cellulose calcium, sodium carboxymethyl cellulose, cellulose, silicified microcrystalline cellulose, cellulose acetate, ceratonia, chitosan, copovidone, corn starch, pregelatinized starch, dextrate, dextrin, dextrose, erythritol, ethylcellulose, fructose, fumaric acid, glyceryl monooleate, glyceryl monostearate, glyceryl palmitostearate, hydroxyethyl cellulose, hydroxyethylmethyl cellulose, hydroxypropyl betadex, hydroxypropyl cellulose, hydroxypropyl starch, hypromellose, hypromellose acetate succinate, kaolin, lactitol, anhydrous lactose, lactose monohydrate, magnesium carbonate, magnesium oxide, maltitol, maltodextrin, maltose, mannitol, methylcellulose, pectin, polaxamer, polycarbophil, polydextrose, poly (DL-lactic acid), polyethylene glycol, polyethylene oxide, polymethacrylate, polyoxyglyceride, polyvinyl alcohol, povidone, shellac, simethicone, sodium alginate, sodium chloride, sorbitol, starch, pregelatinized starch, sucrose, sugar spheres, sulfobutyl ether B-cyclodextrin, titanium dioxide, trehalose, microcrystalline wax, white wax, yellow wax, xanthan gum, xylitol, beeswax, candelilla, carnauba, caranway, sugarcane wax, myrtle wax, gum arabic, locust bean wax, guar gum, alginic acid, carrageenan, or pectin.

According to an embodiment, the coating layer may prevent the breakage of the granules due to the moisturizing agent by including at least one of microcrystalline cellulose, anhydrous lactose, Cellactose 80 (75% of microcrystalline cellulose and 25% of lactose which are co-processed), isomalt, dibasic dihydrate calcium phosphate, calcium carbonate, calcium lactate, dibasic anhydrous calcium phosphate, tribasic calcium phosphate, calcium silicate, calcium sulfate, carbomer, carboxymethyl cellulose calcium, sodium carboxymethyl cellulose, cellulose, silicified microcrystalline cellulose, cellulose acetate, ceratonia, chitosan, copovidone, corn starch, pregelatinized starch, dextrate, dextrin, dextrose, erythritol, ethylcellulose, fructose, fumaric acid, glyceryl monooleate, glyceryl monostearate, glyceryl palmitostearate, hydroxyethyl cellulose, hydroxyethylmethyl cellulose, hydroxypropyl betadex, hydroxypropyl cellulose, hydroxypropyl starch, hypromellose, hypromellose acetate succinate, kaolin, lactitol, anhydrous lactose, lactose monohydrate, magnesium carbonate, magnesium oxide, maltitol, maltodextrin, maltose, mannitol, methylcellulose, pectin, polaxamer, polycarbophil, polydextrose, poly (DL-lactic acid), polyethylene glycol, polyethylene oxide, polymethacrylate, polyoxyglyceride, polyvinyl alcohol, povidone, shellac, simethicone, sodium alginate, sodium chloride, sorbitol, starch, pregelatinized starch, sucrose, sugar spheres, sulfobutyl ether B-cyclodextrin, titanium dioxide, trehalose, microcrystalline wax, white wax, yellow wax, xanthan gum, xylitol, beeswax, candelilla, carnauba, caranway, sugarcane wax, myrtle wax, gum arabic, locust bean wax, guar gum, alginic acid, carrageenan, or pectin.

According to an embodiment, the granules may have a filling density of 0.65 g/cc to 0.80 g/cc based on the entire cigarette filter 200. According to an embodiment, the filling density of the granules may be determined by an injection amount of granules, and the granules may be injected to have the filling density of the granules within the above numerical range, thereby preventing the breakage of the granules.

According to an embodiment, the filling density of the granules may be 0.65 g/cc or more, 0.70 g/cc or more, or 0.75 g/cc or more, 0.80 g/cc or less, 0.75 g/cc or less, or 0.70 g/cc or less, or may be included in a range between two values selected from the above values.

According to an embodiment, the granules may include at least one of activated carbon, cut granules, or red ginseng marc granules. For example, the granules may be activated carbon.

According to an embodiment, the granules may be injected to the paper filter 210 and seated on the surface thereof, and the injection amount of granules may be 3 mg/mm to 5 mg/mm based on the longitudinal direction of the paper filter 210. According to an embodiment, the injection amount of granules may be 3 mg/mm or more or 4 mg/mm or more, may be 5 mg/mm or less or 4 mg/mm or less, or may be included in a range between two values selected from the above values.

According to an embodiment, when the injection amount of granules is 3 mg/mm to 5 mg/mm, it is possible to manufacture a cigarette filter having excellent smoking taste and an excellent transfer amount of a nicotine component and moisture in the mainstream smoke.

According to an embodiment, an average diameter of the granules may be 0.45 mm to 0.60 mm. According to an embodiment, the average diameter of the granules may be 0.45 mm or more, 0.50 mm or more, or 0.55 mm or more, 0.60 mm or less, 0.55 mm or less, or 0.50 mm or less, or may be included in a range between two values selected from the above values.

According to an embodiment, a total amount of sugar in the granules may be 35% or more. According to an embodiment, the higher the amount of sugar in the granules, the more delicious the tobacco taste. According to an embodiment, the total amount of sugar in the granules may be desirably 40% or more.

According to an embodiment, the paper filter 210 may have water resistance of 5% or more. According to an embodiment, the paper filter 210 may have high water resistance so that the moisturizing agent may be easily formed on the surface. According to an embodiment, the water resistance of the paper filter 210 may be desirably 10% or more.

According to an embodiment, the paper filter 210 may further include a flavoring agent. According to an embodiment, the flavoring agent may include an herbal flavoring substance. According to an embodiment, the flavoring agent may be dispersed on at least a portion of the surface of the paper filter 210.

According to an embodiment, the filter wrapper 220 may include a material that may be heated by an induced magnetic field. According to an embodiment, the filter wrapper 220 may include at least one of aluminum (Al), copper (Cu), zinc (Zn), gold (Au), or iron (Fe). According to an embodiment, the filter wrapper 220 may have a cylindrical shape formed of, for example, an aluminum foil, copper foil, or silver foil. According to an embodiment, the material that may be heated by the induced magnetic field may include at least one of an aluminum foil, copper foil, or silver foil.

According to an embodiment of the present disclosure, the cigarette filter may include a paper filter formed by rolling base paper, a moisturizing agent applied to at least a portion of the surface of the paper filter, and a filter wrapper wrapping granules bound to the moisturizing agent and the paper filter.

According to an embodiment, a width of the base paper may be 200 mm to 250 mm.

According to an embodiment, the base paper may have a basis weight of 15 g/m² to 30 g/m².

According to an embodiment, a product of the width and the basis weight of the base paper may be 5.2 g/m to 5.6 g/m.

According to an embodiment, the paper filter may have a cylindrical shape having the circumference of 20 mm to 25 mm.

According to an embodiment, the moisturizing agent may include at least one of glycerin, guar gum, starch, methyl cellulose, EVA, gum arabic, or propylene glycol.

According to an embodiment, an amount of moisturizing agent applied may be 1 mg/mm to 5 mg/mm based on the longitudinal direction of the paper filter.

According to an embodiment, the paper filter may have water resistance of 5% or more.

According to an embodiment, an amount of granules may be 3 mg/mm to 6 mg/mm based on a length of the paper filter.

According to an embodiment, the granules may have coating layers formed on surfaces thereof.

According to an embodiment, the coating layer may include at least one of microcrystalline cellulose, anhydrous lactose, Cellactose 80 (75% of microcrystalline cellulose and 25% of lactose which are co-processed), isomalt, dibasic dihydrate calcium phosphate, calcium carbonate, calcium lactate, dibasic anhydrous calcium phosphate, tribasic calcium phosphate, calcium silicate, calcium sulfate, carbomer, carboxymethyl cellulose calcium, sodium carboxymethyl cellulose, cellulose, silicified microcrystalline cellulose, cellulose acetate, ceratonia, chitosan, copovidone, corn starch, pregelatinized starch, dextrate, dextrin, dextrose, erythritol, ethylcellulose, fructose, fumaric acid, glyceryl monooleate, glyceryl monostearate, glyceryl palmitostearate, hydroxyethyl cellulose, hydroxyethylmethyl cellulose, hydroxypropyl betadex, hydroxypropyl cellulose, hydroxypropyl starch, hypromellose, hypromellose acetate succinate, kaolin, lactitol, anhydrous lactose, lactose monohydrate, magnesium carbonate, magnesium oxide, maltitol, maltodextrin, maltose, mannitol, methylcellulose, pectin, polaxamer, polycarbophil, polydextrose, poly (DL-lactic acid), polyethylene glycol, polyethylene oxide, polymethacrylate, polyoxyglyceride, polyvinyl alcohol, povidone, shellac, simethicone, sodium alginate, sodium chloride, sorbitol, starch, pregelatinized starch, sucrose, sugar spheres, sulfobutyl ether B-cyclodextrin, titanium dioxide, trehalose, microcrystalline wax, white wax, yellow wax, xanthan gum, xylitol, beeswax, candelilla, camauba, caranway, sugarcane wax, myrtle wax, gum arabic, locust bean wax, guar gum, alginic acid, carrageenan, or pectin.

According to an embodiment, the granules may have a filling density of 0.65 g/cc to 0.80 g/cc based on the entire cigarette filter.

According to an embodiment, the granules may include at least one of activated carbon, cut granules, or red ginseng marc granules.

According to an embodiment, an injection amount of granules may be 3 mg/mm to 5 mg/mm based on the longitudinal direction of the paper filter.

According to an embodiment, the granules may have an average diameter of 0.45 mm to 0.60 mm.

According to an embodiment, a total amount of sugar in the granules may be 35% or more.

According to an embodiment, the paper filter may further include a flavoring agent.

According to an embodiment of the present disclosure, a cigarette may include a cigarette column portion, a cigarette filter portion positioned at one side of the cigarette column portion and including one or more cigarette filters, and a tip paper wrapping the cigarette filter portion and a portion of the cigarette column portion.

According to an embodiment, a content of the granules may be 0.3% by mass to 5% by mass with respect to a total content of the cigarette filter portion.

According to an embodiment, the tip paper may include at least one of aluminum (Al), copper (Cu), zinc (Zn), gold (Au), or iron (Fe).

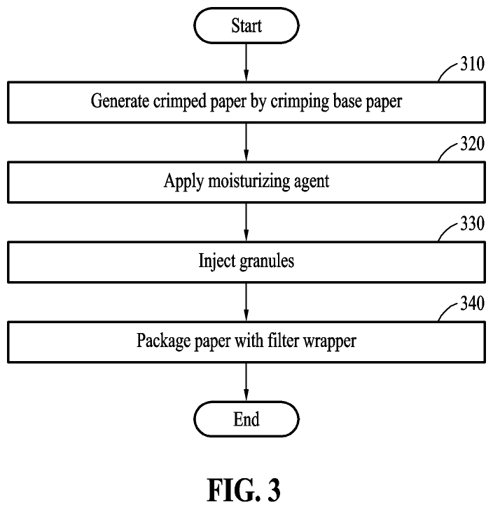

FIG. 3 is a flowchart of a manufacturing process of a cigarette filter according to an embodiment of the present disclosure.

A method of manufacturing a cigarette filter according to another aspect of the present disclosure may include operation 310 of generating crimped paper by crimping base paper, operation 320 of applying a moisturizing agent to the crimped paper through a plurality of nozzles, operation 330 of injecting granules onto the paper containing the moisturizing agent, and operation 340 of packaging the paper, on which the granules are seated, with a filter wrapper.

FIG. 4 is a schematic diagram of a manufacturing device for a cigarette filter according to an embodiment of the present disclosure.

FIG. 4 shows a manufacturing device for manufacturing a cigarette filter (the cigarette filter 20 of FIG. 1).

According to an embodiment, operation 310 of generating crimped paper by crimping base paper may be performed by a first roller 411 and a second roller 412, and base paper 401 may be crimped to generate crimped paper. According to an embodiment, the base paper 401 may be injected into a gap between the first roller 411 and the second roller 412, and at this time, the base paper 401 may be transported by various transfer means. According to an embodiment, the transfer means of the base paper 401 may be configured with rollers, conveyor belts, or both. A transfer path of the base paper 401 may be variously set according to the number and/or arrangement of rollers and/or conveyor belts.

According to an embodiment, the transfer path of the base paper 401 may be set in various ways, and according to an example, it may be set as a straight path, a curved path, or a U-shaped path. However, the transfer path of the base paper 401 may be determined by various factors such as the arrangement of a processing device, and is not limited to the path described above.

According to an embodiment, the first roller 411 and the second roller 412 may compress, crumple, and crimp the base paper 401. According to an embodiment, the first roller 411 and the second roller 412 may rotate in opposite directions to transfer the crimped base paper 401 to a next processing device. The base paper 401 may be subjected to the crimping process to generate crimped paper 402, and a sufficient tensile force may be applied to the crimped paper 402. According to an embodiment, the crimped paper 402 may pass through a moisturizing agent injection device 420 while floating in the air.

According to an embodiment, in order to effectively compress and crumple the base paper 401, the first roller 411 and the second roller 412 may each include unevenness. According to an embodiment, the crimping process may be smoothly performed by a rotational force of the first roller 411 and the second roller 412, and the base paper 401 may be appropriately compressed and crumpled so that the moisturizing agent is applied, and this may generate the crimped paper 402.

According to an embodiment, through operation 320 of applying the moisturizing agent, the moisturizing agent may be applied to the crimped paper 402 through a plurality of nozzles to produce paper 403 containing the moisturizing agent. According to an embodiment, operation 320 of applying the moisturizing agent may be performed using the moisturizing agent application device 420.

According to an embodiment, operation 320 of applying the moisturizing agent may be performed by spraying 0.5 mg/mm to 5 mg/mm of the moisturizing agent based on the longitudinal direction of the crimped paper 403. According to an embodiment, an amount of the moisturizing agent applied may be 4 mg/mm or less, 3 mg/mm or less, 2 mg/mm or less, or 1 mg/mm or less, desirably 0.5 mg/mm to 4 mg/mm, 0.5 mg/mm to 3 mg/mm, or 0.5 mg/mm to 2 mg/mm.

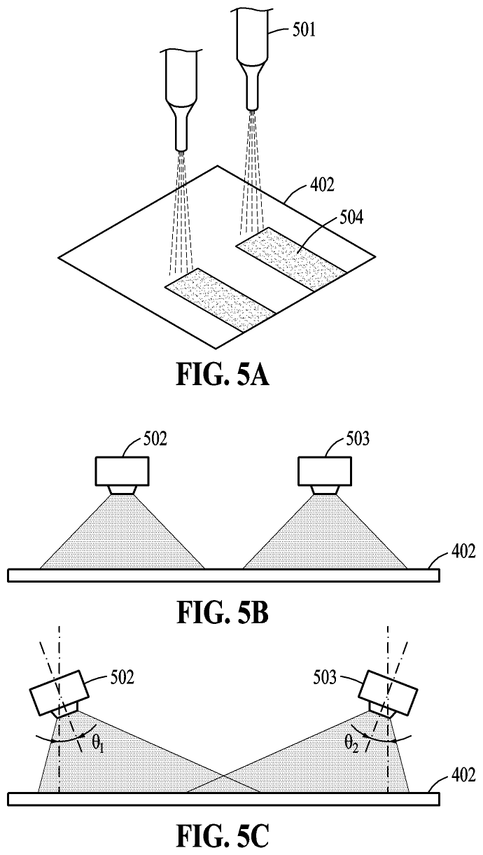

FIG. 5 is a conceptual diagram of a method of applying a moisturizing agent in a moisturizing agent application device according to an embodiment of the present disclosure.

Referring to FIG. 5A, the moisturizing agent application device 420 may include a plurality of nozzles 501. According to an embodiment, the crimped paper 402 may be transferred at a certain distance from the nozzles 501, and the moisturizing agent sprayed from the nozzle 501 may be applied to a surface of the crimped paper 402. According to an embodiment, in operation of producing paper containing the moisturizing agent, the moisturizing agent may be sprayed from the nozzles 501 positioned to be spaced apart from the crimped paper 402. According to an embodiment, the nozzles 501 may be disposed to be spaced apart from the crimped paper 402.

According to an embodiment, the nozzles 501 may be positioned to be upwardly spaced apart from the transfer path of the crimped paper 402. When the nozzles 501 spray the moisturizing agent in a fixed direction, the moisturizing agent may be applied while the crimped paper 402 moves along the transfer path. According to an embodiment, when the transfer path of the crimped paper 402 is straight, traces 504 of the moisturizing agent sprayed onto the crimped paper 402 may be formed as straight lines.

According to an embodiment, the plurality of nozzles 501 may be used to evenly apply the moisturizing agent onto the crimped paper 402. For example, two to ten nozzles 501 may be used, and the plurality of nozzles 501 may be arranged in a row in a direction perpendicular to the transfer path of the crimped paper 402. According to an embodiment, the number of the plurality of nozzles 501 may be desirably two or three.

According to an embodiment, as the plurality of nozzles 501 each spray the moisturizing agent in a predetermined direction, the moisturizing agent may be sprayed onto the crimped paper 402 to form the plurality of parallel traces 504. Since the amount of moisturizing agent corresponding to the number of nozzles 501 may be sprayed at the same time, a content of the moisturizing agent in the crimped paper 402 may be increased. According to an embodiment, as the content of the moisturizing agent in the crimped paper 402 increases, a conditioning period may be shortened and it is easy to achieve desired suction resistance.

In this case, the conditioning period may refer to a period during which a moisturizing agent is absorbed into a paper filter of a cigarette filter and spreads evenly. In order to shorten the conditioning period, it is necessary to evenly apply the moisturizing agent onto the paper as possible in operation 320 of applying the moisturizing agent, so that the moisturizing agent rapidly spreads throughout the paper.

FIGS. 5B and 5C are conceptual diagrams showing the spraying of the nozzles 501 seen from the transfer path of the crimped paper 402. Referring to FIGS. 5B and 5C, the plurality of nozzles 501 may include a first nozzle 502 and a second nozzle 503, and an axis of each of the first nozzle 502 and the second nozzle 503 may form a predetermined angle with a perpendicular direction of the crimped paper 402.

According to an embodiment, the plurality of nozzles 501 may be disposed to be spaced apart from each other. For example, the axis of the first nozzle 502 may form a first angle θ₁ with the perpendicular direction of the crimped paper 402, and the axis of the second nozzle 503 may form a second angle θ₂ with the perpendicular direction of the crimped paper 402.

According to an embodiment of FIG. 5B, the first angle θ₁ and the second angle θ₂ may each be 0 degrees. According to an embodiment of FIG. 5C), the first angle θ₁ and the second angle θ₂ may each be 15 degrees to 45 degrees.

According to an embodiment, the plurality of nozzles include the first nozzle 502 and the second nozzle 503, and the first nozzle 502 and the second nozzle 503 may be tilted toward each other based on the perpendicular direction of the crimped paper 402. According to an embodiment, the axes of the first nozzle 502 and the second nozzle 503 may form the first angle θ₁ and the second angle θ₂ with the perpendicular direction of the crimped paper 402, respectively, and a perpendicular line of the crimped paper 402, the axis of the first nozzle 502, and the axis of the second nozzle 503 may be positioned on one plane.

According to an embodiment, the axis of the first nozzle 502 may have an angle of 15 degrees to 45 degrees toward the second nozzle 503 based on the perpendicular direction of the crimped paper 402, and the axis of the second nozzle 503 may have an angle of 15 degrees to 45 degrees toward the first nozzle 502 based on the perpendicular direction of the crimped paper 402. According to an embodiment, the first angle θ₁ formed between the axis of the first nozzle 502 and the perpendicular direction of the crimped paper 402 may be formed toward the second nozzle, and the first angle θ₁ may be 15 degrees to 45 degrees. According to an embodiment, the second angle θ₂ formed between the axis of the second nozzle 503 and the perpendicular direction of the crimped paper 402 may be formed toward the first nozzle, and the second angle θ₂ may be 15 degrees to 45 degrees.

According to an embodiment, since each axis of the first nozzle 502 and the second nozzle forms a predetermined angle with the perpendicular direction of the crimped paper 402, the moisturizing agent may be evenly sprayed onto the crimped paper 402, and the moisturizing agent may also be evenly sprayed onto sides of the crimped paper 402 without being biased to the center.

According to an embodiment, in operation 320 of applying the moisturizing agent, the moisturizing agent may be applied by being heated to 80° C. to 120° C. According to an embodiment, in operation 320 of applying the moisturizing agent, the moisturizing agent may be applied by setting a viscosity of the moisturizing agent to 0.008 Ns/m² to 0.08 Ns/m². According to an embodiment, the viscosity of the moisturizing agent may be measured in a temperature range of 60° C. to 120° C. According to an embodiment, the moisturizing agent may have a viscosity of desirably 0.014 Ns/m² to 0.03 Ns/m². According to an embodiment, the viscosity of the moisturizing agent may decrease as a measurement temperature increases, and the viscosity of the moisturizing agent according to an embodiment measured at 100° C. may be 0.008 Ns/m² to 0.03 Ns/m².

According to an embodiment, the moisturizing agent may include at least one of glycerin, guar gum, starch, methyl cellulose, EVA, gum arabic, or propylene glycol.

According to an embodiment, tobacco extract may be added to the moisturizing agent. According to an embodiment, a cigarette filter (e.g., the cigarette filter 200 of FIG. 2) containing the moisturizing agent, to which the tobacco extract is added, may simultaneously generate an aerosol and nicotine when heated.

According to an embodiment, the tobacco extract may include at least one of a nicotine salt, nicotine, nicotine base, prenicotine, or nicotine derivative. In an example, the nicotine salt is a substance naturally formed in leaf tobacco, and may be generated by a reaction of nicotine and an acid substance. Those skilled in the art may easily understand that the acid substance may include a lactic acid or pyruvic acid, and may further include an organic acid that may react with nicotine to form a nicotine salt.

According to an embodiment, the paper 403 containing the moisturizing agent produced in operation 320 of applying the moisturizing agent may be produced into paper 404 on which the granules are seated through operation 330 of injecting the granules. According to an embodiment, operation 330 of injecting the granules may be performed by randomly injecting the granules onto the paper 403 containing the moisturizing agent in a granule injection device 430, and specifically, the granules are seated on the moisturizing agent.

According to an embodiment, the paper 404, on which the granules are seated, produced in operation 330 of injecting the granules may be subjected to operation 340 of packaging the paper with the filter paper. According to an embodiment, the paper 404, on which the granules are seated, may be transferred through a discharge port 440 and collected in one place. According to an embodiment, the discharge port 440 may have a wide inlet and a narrow outlet, and may collect the paper 404, on which the granules are seated, in a narrow space in a cylindrical shape.

According to an embodiment, the paper 404, on which the granules are seated, may pass through the discharge port 440 to be collected in the form suitable for packaging as filter paper. According to an embodiment, the outlet discharge port 440 may have a shape with a wide inlet and a circular outlet which gradually narrows and has a diameter similar to a diameter of a cigarette (e.g., the cigarette 1 of FIG. 1). According to an embodiment, when the paper 404, on which the granules are seated, passes through the discharge port 440, it is rolled to have a diameter similar to the diameter of the cigarette, and paper filter thus formed (e.g., the paper filter 210 of FIG. 2) may be discharged through the outlet of the discharge port 440.

According to an embodiment, the paper 404, on which the granules are seated and which is discharged through the discharge port 440, may be packaged with a filter wrapper (e.g., the filter wrapper 220 of FIG. 2). According to an embodiment, the paper 404, on which the granules are seated, may be packaged with the filter wrapper and produced into a cigarette filter 405. According to an embodiment, the paper 404, on which the granules are seated and which is discharged through the discharge port 440, may be packaged and fixed through the filter wrapper to prevent unraveling due to a restoring force.

According to an embodiment, operation 310 of generating the crimped paper, operation 320 of applying the moisturizing agent, operation 330 of injecting the granules, and operation 340 of packaging the filter wrapper may be performed as the paper is transferred along a preset path.

According to an embodiment of the present disclosure, a method of manufacturing a cigarette filter may include generating crimped paper by crimping base paper, applying a moisturizing agent to the crimped paper through a plurality of nozzles, injecting granules onto the paper containing the moisturizing agent, and packaging the paper, on which the granules are seated, with a filter wrapper.

According to an embodiment, the applying of the moisturizing agent may be performed by spraying 0.5 mg/mm to 5 mg/mm of the moisturizing agent based on the longitudinal direction of the crimped paper.

According to an embodiment, the number of the plurality of nozzles may be two or three.

According to an embodiment, the producing of the paper containing the moisturizing agent may include spraying the moisturizing agent from a plurality of nozzles positioned to be spaced apart from the crimped paper.

According to an embodiment, the plurality of nozzles may be disposed to be spaced apart from the crimped paper.

According to an embodiment, the plurality of nozzles may be disposed to be spaced apart from each other, and an axis of the nozzle may have an angle of 15 degrees to 45 degrees based on a perpendicular direction of the crimped paper.

According to an embodiment, the plurality of nozzles may include a first nozzle and a second nozzle, an axis of the first nozzle may have an angle of 15 degrees to 45 degrees toward the second nozzle based on the perpendicular direction of the crimped nozzle, and an axis of the second nozzle may have an angle of 15 degrees to 45 degrees toward the first nozzle based on the perpendicular direction of the crimped paper.

According to an embodiment, the manufacturing of the paper containing the moisturizing agent may include applying the moisturizing agent by heating the moisturizing agent to 80° C. to 120° C.

According to an embodiment, the moisturizing agent may have a viscosity of 0.008 Ns/m² to 0.08 Ns/m².

According to an embodiment, the moisturizing agent may include at least one of glycerin, guar gum, starch, methyl cellulose, EVA, gum arabic, or propylene glycol.

According to an embodiment, tobacco extract may be added to the moisturizing agent.

According to an embodiment, the tobacco extract may include at least one of a nicotine salt, nicotine, nicotine base, prenicotine, or nicotine derivative.

According to an embodiment, the filter wrapper may include a material that may be heated by an induced magnetic field.

According to an embodiment, the material that may be heated by the induced magnetic field may include at least one of an aluminum foil, copper foil, or silver foil.

According to an embodiment, the generating of the crimped paper, the applying of the moisturizing agent, the injecting of the granules, and the packaging of the filter wrapper may be performed as the paper is transferred along a preset path.

Hereinafter, the present disclosure will be described in detail based on examples and comparative examples.

However, the following examples are only for illustrating the present disclosure, and the present disclosure is not limited to the following examples.

### Experimental Example 1

Cigarette filters were manufactured using various base papers to confirm granule stability according to the types and physical properties of the base papers. At this time, the cigarette filters were manufactured through operations of generating crimped paper by crimping base paper, applying a moisturizing agent to the crimped paper through a plurality of nozzles, injecting granules onto the paper containing the moisturizing agent, and packaging the paper, on which the granules are seated, with a filter wrapper. As shown in Table 1 below, various types of base paper were used, 1 mg/mm of glycerin was applied as the moisturizing agent, and 5 mg/mm of shellac-coated activated carbon was injected as the granules. Table 1 below showed the stability of the granules of the cigarette filter according to various examples with different types of base paper according to Experimental Example 1.

TABLE 1

| | Basis | | Reference | | | |
|---|---|---|---|---|---|---|
| | weight | | suction | Width | Width × | |
| | of base | Type of | resistance | of base | basis | Result of |
| Classi- | paper | base | (PD) | paper | weight | seating of |
| fication | [g/m²] | paper | [mmWG] | [mm] | [g/m] | granules |
| Example 1 | 35 | Crepe | 80 | 150 | 5.25 | A large |
| | | paper | | | | amount of |
| | | | | | | granules |
| | | | | | | fell off |
| Example 2 | 60 | Crepe | 80 | 90 | 5.40 | A large |
| | | paper | | | | amount of |
| | | | | | | granules |
| | | | | | | fell off |
| Example 3 | 16 | Non- | 80 | 340 | 5.44 | A large |
| | | porous | | | | amount of |
| | | paper | | | | granules |
| | | | | | | fell off |
| Example 4 | 24 | Non- | 80 | 220 | 5.28 | Good |
| | | porous | | | | stability of |
| | | paper | | | | granules |
| Example 5 | 24 | Porous | 80 | 220 | 5.28 | Good |
| | | paper | | | | stability of |
| | | | | | | granules |
| Example 6 | 26.5 | Non- | 80 | 210 | 5.565 | Good |
| | | porous | | | | stability of |
| | | paper | | | | granules |

Referring to Table 1, it may be confirmed that, when the base paper is non-porous, the stability of the granules is excellent, when the basis weight is 15 g/m² to 30 g/m², the stability of the granules is excellent, and when the product of the width and the basis weight of the base paper is 5.2 g/m to 5.6 g/m, the stability of the granules is excellent.

### Experimental Example 2

In order to evaluate the taste of cigarettes depending on the amount of granules injected to the cigarette filter, cigarette filters were manufactured with various amounts of granules injected. At this time, the cigarette filters were manufactured through operations of generating crimped paper by crimping base paper, applying a moisturizing agent to the crimped paper through a plurality of nozzles, injecting granules onto the paper containing the moisturizing agent, and packaging the paper, on which the granules are seated, with a filter wrapper. As shown in Table 2 below, different amounts of granules injected were evaluated. Non-porous paper having a basis weight of 24 g/m² was used as the base paper, 1 mg/mm of glycerin was applied as the moisturizing agent, and shellac-coated activated carbon was used as the granules. At this time, the shellac-coated activated carbon had an average diameter of 0.45 mm to 0.60 mm and an equivalent weight of 0.35%. Table 2 below showed the cigarette filters according to the different amounts of granules injected according to Experimental Example 2 and evaluation results of the taste of cigarettes including the cigarette filters.

TABLE 2

| | Amount of | | Result of | |
|---|---|---|---|---|
| | granules | | analyzing | |
| | injected | Evaluation | smoke | |
| Classification | [mg/mm] | of taste | component | Note |
| Example 7 | 1 | Poor smoking | Insufficient | None |
| | | taste | transfer amount | |
| | | | of nicotine and | |
| | | | moisture | |
| Example 8 | 2 | Poor smoking | Insufficient | None |
| | | taste | transfer amount | |
| | | | of nicotine and | |
| | | | moisture | |
| Example 9 | 3 | Poor smoking | Insufficient | None |
| | | taste | transfer amount | |
| | | | of nicotine and | |
| | | | moisture | |
| Example 10 | 4 | Excellent | Excellent | None |
| | | smoking taste | transfer amount | |
| | | | of nicotine and | |
| | | | moisture | |
| Example 11 | 5 | Excellent | Excellent | None |
| | | smoking taste | transfer amount | |
| | | | of nicotine and | |
| | | | moisture | |
| Example 12 | 6 | Poor smoking | Insufficient | None |
| | | taste | transfer amount | |
| | | | of nicotine and | |
| | | | moisture | |

Referring to Table 2 above, it may be confirmed that, when the amount of granules injected is 3 mg/mm to 5 mg/mm, the transfer amount of nicotine and moisture is good, and the smoking taste of the cigarettes using such cigarette filters is good.

### Experimental Example 3

To evaluate the granule stability according to the types of moisturizing agent of the cigarette filter, cigarette filters were manufactured using various moisturizing agents. At this time, the cigarette filters were manufactured through operations of generating crimped paper by crimping base paper, applying a moisturizing agent to the crimped paper through a plurality of nozzles, injecting granules onto the paper containing the moisturizing agent, and packaging the paper, on which the granules are seated, with a filter wrapper. As shown in Table 3 below, different moisturizing agents were evaluated. Non-porous paper having a basis weight of 24 g/m² was used as the base paper, 1 mg/mm of moisturizing agent was applied, and shellac-coated activated carbon was used as the granules. Table 3 below showed the granule stability according to different types of moisturizing agents according to Experimental Example 3.

TABLE 3

| | Type of | | |
|---|---|---|---|
| | moisturizing | Stability | |
| Classification | agent | of granules | Note |
| Example 13 | EVA | Excellent | Off-flavor in |
| | | | smoking taste |
| Example 14 | Guar gum | Excellent | Excellent long- |
| | | | term stability |
| Example 15 | Glycerin | Excellent | Insufficient long- |
| | | | term stability, |
| | | | but excellent taste |
| Example 16 | Methyl | Excellent | Off-flavor in |
| | cellulose | | smoking taste |

Referring to Table 3 above, it may be confirmed that all of EVA, guar gum, glycerin, and methyl cellulose may be used as the moisturizing agent to improve the stability of the granules, and there is a slight difference only in the occurrence of off-flavor.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

1. A cigarette filter comprising:
a paper filter that is formed by rolling base paper;
a moisturizing agent that is applied to at least a portion of a surface of the paper filter;
granules that are bound to the moisturizing agent; and
a filter wrapper that wraps the paper filter,
wherein an amount of the granules is 3 mg/mm to 6 mg/mm based on a length of the paper filter.

2. The cigarette filter of claim 1, wherein each granule is formed with a coating layer on a surface.

3. The cigarette filter of claim 2, wherein the coating layer comprises at least one of microcrystalline cellulose, anhydrous lactose, Cellactose 80 (75% of microcrystalline cellulose and 25% of lactose which are co-processed), isomalt, dibasic dihydrate calcium phosphate, calcium carbonate, calcium lactate, dibasic anhydrous calcium phosphate, tribasic calcium phosphate, calcium silicate, calcium sulfate, carbomer, carboxymethyl cellulose calcium, sodium carboxymethyl cellulose, cellulose, silicified microcrystalline cellulose, cellulose acetate, ceratonia, chitosan, copovidone, corn starch, pregelatinized starch, dextrate, dextrin, dextrose, erythritol, ethylcellulose, fructose, fumaric acid, glyceryl monooleate, glyceryl monostearate, glyceryl palmitostearate, hydroxyethyl cellulose, hydroxyethylmethyl cellulose, hydroxypropyl betadex, hydroxypropyl cellulose, hydroxypropyl starch, hypromellose, hypromellose acetate succinate, kaolin, lactitol, anhydrous lactose, lactose monohydrate, magnesium carbonate, magnesium oxide, maltitol, maltodextrin, maltose, mannitol, methylcellulose, pectin, polaxamer, polycarbophil, polydextrose, poly (DL-lactic acid), polyethylene glycol, polyethylene oxide, polymethacrylate, polyoxyglyceride, polyvinyl alcohol, povidone, shellac, simethicone, sodium alginate, sodium chloride, sorbitol, starch, pregelatinized starch, sucrose, sugar spheres, sulfobutyl ether B-cyclodextrin, titanium dioxide, trehalose, microcrystalline wax, white wax, yellow wax, xanthan gum, xylitol, beeswax, candelilla, carnauba, caranway, sugarcane wax, myrtle wax, gum arabic, locust bean wax, guar gum, alginic acid, carrageenan, or pectin.

4. The cigarette filter of claim 1, wherein the granules have a filling density of 0.65 g/cc to 0.80 g/cc based on the entire cigarette filter.

5. The cigarette filter of claim 1, wherein the granules comprise at least one of activated carbon, cut granules, and red ginseng marc granules.

6. The cigarette filter of claim 1, wherein an amount of granules injected is 3 milligrams/millimeters (mg/mm) to 5 mg/mm based on a longitudinal direction of the paper filter.

7. The cigarette filter of claim 1, wherein the granules have an average diameter of 0.45 millimeters (mm) to 0.60 mm.

8. The cigarette filter of claim 1, wherein a total amount of sugar in the granules is 35% or more.

9. The cigarette filter of claim 1, wherein the paper filter further comprises a flavoring agent.

10. A cigarette comprising:
a cigarette column portion;
a cigarette filter portion that is positioned at one side of the cigarette column portion and comprises one or more cigarette filters; and
a tip paper that wraps the cigarette filter portion and a portion of the cigarette column portion,
wherein at least one of the one or more cigarette filters comprises:
a paper filter that is formed by rolling base paper;
a moisturizing agent that is applied to at least a portion of a surface of the paper filter;
granules that are bound to the moisturizing agent; and
a filter wrapper that wraps the paper filter, and
wherein an amount of the granules is 3 mg/mm to 6 mg/mm based on a length of the paper filter.

11. The cigarette of claim 10, wherein a content of the granules is 0.3% by mass to 5% by mass based on the entire cigarette filter portion.

12. The cigarette of claim 10, wherein the tip paper comprises at least one of aluminum (Al), copper (Cu), zinc (Zn), gold (Au), or iron (Fe).
